(19) United States
(12) Patent Application Publication
(10) Pub. No.: US 2010/0133735 A1
(43) Pub. Date: Jun. 3, 2010

(54) SUBSTRATE HOLDING APPARATUS, SUBSTRATE HOLDING METHOD, EXPOSURE APPARATUS, AND DEVICE MANUFACTURING METHOD

(75) Inventor: Ken Katsuta, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/625,369

(22) Filed: Nov. 24, 2009

(30) Foreign Application Priority Data
Nov. 28, 2008 (JP) 2008-305681

(51) Int. Cl. B25B 11/00; B23Q 7/00

(52) U.S. Cl. 269/21; 29/559

(57) ABSTRACT

A substrate holding apparatus configured to hold a substrate by vacuum holding includes a rim which has a circumferential shape and is configured to support the substrate, a projection portion configured to support the substrate in an inner area surrounded by the rim, an exhaust unit configured to exhaust gas from an inner space within the rim to attract and support the substrate, a lift pin configured to load the substrate on the rim and the projection portion, a supply unit configured to supply gas to the space surrounded by the rim, and a control unit configured to control a flow rate of the gas supplied from the supply unit, wherein when the gas is exhausted by the exhaust unit, the control unit starts supplying the gas before the substrate contacts the rim and the projection portion, and controls the flow rate of the supplied gas in order to reduce a deformation in the substrate caused by exhaust of the gas.

### BACKGROUND OF THE INVENTION

1. Field of the Invention

The present invention relates to a substrate holding apparatus and a substrate holding method configured to hold a substrate which is a workpiece such as a wafer processed by an exposure apparatus, and to an exposure apparatus which includes a substrate holding apparatus.

2. Description of the Related Art

Japanese Patent Application Laid-Open No. 2004-140071 discusses a substrate holding apparatus in an exposure apparatus which is used in the fabrication of conventional semiconductor elements and liquid crystal display elements.

The substrate holding apparatus discussed in Japanese Patent Application Laid-Open No. 2004-140071 includes a wafer chuck which has pin-shaped projection portions formed by etching and peripheral ridge projection portions formed like an embankment. The wafer chuck supports a substrate as a workpiece such as a wafer, which is loaded on an X-Y stage. The substrate holding apparatus further includes vacuum suction holes which extend from a bottom surface to a top surface of a wafer chuck and communicate with a vacuum source. A conveyed substrate is loaded on the wafer chuck, and under this condition, the substrate is attached firmly on the wafer chuck with the pin-shaped projection portions and the peripheral ridge projection portions by exhausting internal gas through the vacuum suction holes. Thus a deformation of the substrate is corrected. Therefore, flatness of the substrate is maintained, and accurate exposure and pattern transfer can be performed.

The substrate holding apparatus is described with reference to a schematic diagram in FIG. 6. A wafer chuck 8 includes three through-holes 3 (3a and 3b) extending from the bottom surface to a substrate loading side of the wafer chuck 8, and peripheral ridge projection portions 4 (4a and 4b) provided around the through-holes 3.

The substrate holding apparatus includes an outer circumferential rim 5 along the outer circumference of the wafer chuck 8, and projection portions 6 provided in an inside area surrounded by the outer circumferential rim 5. A flat wafer loading surface 2 to be loaded with a wafer 1 as a workpiece is formed on top surfaces of the peripheral ridge portion s 4, the outer circumferential rim 5, and the projection portions 6.

Though only the through-holes 3a and 3b, and the peripheral ridge portions 4a and 4b are illustrated in FIG. 6, since the through-holes 3 and the peripheral ridge portions 4 are provided 120 degrees apart for example, in actuality, three through-holes 3 and three projection portions 4 are provided respectively.

The substrate holding apparatus includes lift pins 9 (9a and 9b) which are configured to deliver the wafer 1 and pass through the through-holes. The substrate holding apparatus further includes an elevating mechanism 10 configured to move the lift pins vertically, and a wafer chuck support member, not shown, configured to support the wafer chuck 8. Because the lift pins 9 are provided 120 degrees apart for example, in fact, there are three lift pins 9.

In addition, a vacuum pipe system 11 configured to attract and hold the wafer 1 on the loading surface 2 by reducing a pressure in a space defined by the loaded wafer 1, the loading surface 2, the peripheral ridge portions 4, the outer circumferential rim 5, and the projection portions 6. Further, a vacuum pipe system 12 is provided to attract the wafer 1 to the lift pins 9.

An exposure sequence for performing exposure and transfer in the above configuration is described with reference to a flowchart in FIG. 7. In FIG. 7, a substrate is described as a wafer.

In step S1, vacuum suction of the lift pins 9 is started. At the same time, in step S2, an external conveyance apparatus, not shown, by using its conveying hand, loads the wafer 1 as a workpiece on the lift pins 9 waiting in a state protruding over the loading surface 2.

In step S3, when the conveying hand is retreated, the elevating mechanism 10 quickly lowers the lift pins 9, so that the wafer 1 approaches the wafer chuck 8. In step S4, under this condition, the vacuum suction of the wafer chuck 8 is started. Then in step S5, the wafer 1 comes into contact with the wafer chuck 8.

At this point, just before or just after the wafer 1 contacts the wafer chuck 8, vacuum suction is started via the vacuum pipe system 11. In step S6, a vacuum status is checked, and the wafer 1 is attracted and held on the loading surface 2, and its flatness is corrected. Under this condition, a semiconductor exposure apparatus performs exposure and transfer to the wafer 1.

When exposure and transfer are finished, in step S7, the wafer 1 is separated from the lift pins 9 by an operation reversing the operation described above. Then, in step S8, the holding of the wafer 1 is released, and the wafer 1 is recovered.

In the above described substrate holding apparatus, a wafer supported by a plurality of lift pins is vacuum held to the substrate holding apparatus. In the vacuum holding process, a suction operation is started by a suction unit of a vacuum system, and then the wafer is lowered and attracted to the wafer chuck. Conventionally, the suction operation is started before the wafer is delivered completely to the substrate holding apparatus. This is because if the suction operation is started after a wafer is loaded completely, it takes long time until the pressure decreases, which causes a decrease in throughput.

However, because the suction operation starts before a wafer is completely delivered to the substrate holding apparatus, as the wafer approaches the substrate holding apparatus, a pressure in a space which has been under idle suction starts decreasing. When the pressure drops sharply, a distortion caused by deformation of the wafer which is generated immediately before the attraction of the wafer is started, occurs on an attraction surface between the wafer and the substrate holding apparatus and remains after the wafer is attracted due to a frictional force, which deforms the surface of the wafer.

### SUMMARY OF THE INVENTION

The present invention is directed to a substrate holding apparatus capable of reducing local distortion of a substrate when the substrate is attracted and held.

According to an aspect of the present invention, a substrate holding apparatus configured to hold a substrate by vacuum holding includes a rim which has a circumferential shape and is configured to support the substrate, a projection portion configured to support the substrate in an inner area surrounded by the rim, an exhaust unit configured to exhaust gas from an inner space within the rim to attract and support the substrate, a lift pin configured to load the substrate on the rim and the projection portion, a supply unit configured to supply gas to the space surrounded by the rim, and a control unit configured to control a flow rate of the gas supplied from the supply unit, wherein when the gas is exhausted by the exhaust unit, the control unit starts supplying the gas before the substrate contacts the rim and the projection portion, and controls the flow rate of the supplied gas in order to reduce a deformation in the substrate caused by exhaust of the gas.

According to another aspect of the present invention, a method for holding a substrate in a substrate holding apparatus which includes a rim which has a circumferential shape and is configured to support the substrate, a projection portion configured to support the substrate in an inner area surrounded by the rim, an exhaust unit configured to exhaust gas from an inner space within the rim to attract and support the substrate, a lift pin configured to load the substrate on the rim and the projection portion, and, a supply unit configured to supply gas to the space surrounded by the rim. The method includes, when the substrate is loaded, exhausting the gas by the exhaust unit while supplying the gas by the supply unit to reduce a deformation in the substrate caused by the exhaust, and loading the substrate on the rim and the projection portion.

According to yet another aspect of the present invention, a substrate holding apparatus configured to hold a substrate with vacuum by loading the substrate while exhausting the gas from a space includes a supply unit configured to supply gas into the space, and a control unit configured to control a flow rate of the gas supplied from the supply unit, wherein the control unit starts supplying the gas before the substrate is loaded and controls the flow rate of the supplied gas in order to reduce deformation in the substrate caused by the exhaust of the gas.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating a sectional view of a substrate holding apparatus according to a first exemplary embodiment of the present invention.

FIG. 2 is a flowchart illustrating a procedure for holding a substrate by the substrate holding apparatus in FIG. 1.

FIG. 3 is a schematic diagram illustrating a sectional view of a substrate holding apparatus according to a second exemplary embodiment of the present invention.

FIG. 4 is a schematic diagram illustrating a plan view of a substrate holding apparatus according to a third exemplary embodiment of the present invention.

FIG. 5 illustrates a general structure of an exposure apparatus including a substrate holding apparatus according to an exemplary embodiment of the present invention.

FIG. 6 is a schematic diagram illustrating a sectional view of a conventional substrate holding apparatus.

FIG. 7 is a flowchart illustrating a procedure for holding a substrate by a conventional substrate holding apparatus.

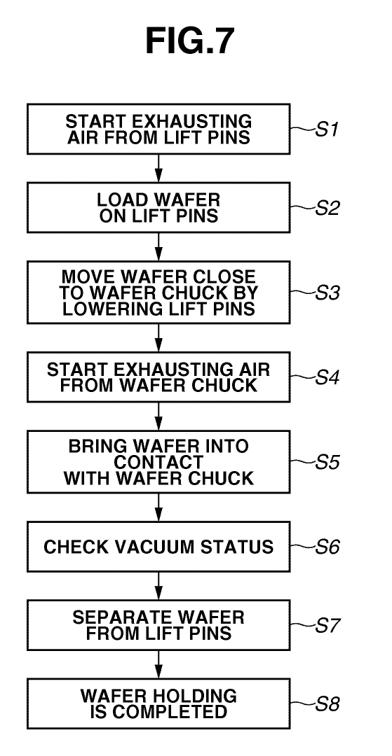

### DESCRIPTION OF THE EMBODIMENTS

Various exemplary embodiments, features, and aspects of the present invention will be described in detail below with reference to the drawings.

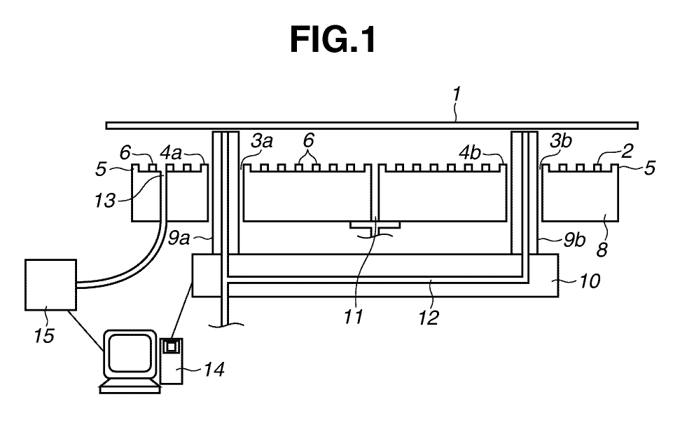

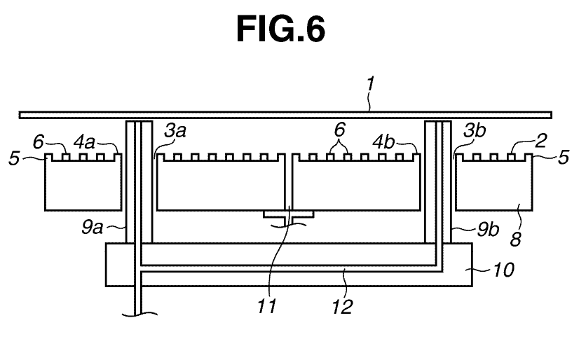

FIG. 1 is a schematic diagram of a substrate holding apparatus according to a first exemplary embodiment of the present invention. In the present exemplary embodiment, a wafer is used as a substrate. The same numerals in FIG. 6 indicate the similar parts.

In FIG. 1, the wafer chuck 8 has a wafer loading surface 2 to load a wafer (substrate) 1 thereon. The loading surface 2 is a flat plane formed on top surfaces of the projection portions 6. The loading surface 2 is also formed on top surfaces of peripheral ridge portion s 4a and 4b around through-holes 3a and 3b and outer circumferential rim 5 formed on the outer circumference of the wafer chuck 8. The outer circumferential rim 5 has a circumferential shape and supports the wafer 1. The projection portions 6 also support the wafer 1 and are provided in an inner area surrounded by the outer circumferential rim 5.

The wafer chuck 8 includes a vacuum pipe system 11 (exhaust unit) as a second negative pressure suction unit which is connected to a negative pressure source, not shown. The vacuum pipe system 11 exhausts a gas in the inner space of the outer circumferential rim 5 to attract and hold the wafer 1. The wafer 1 is placed on the loading surface 2, and a pressure in a space formed by the wafer 1, the projection portions 6, the peripheral ridge portions 4a and 4b, and the outer circumferential rim 5 is reduced via the vacuum pipe system 11. Therefore the wafer is attracted and the flatness thereof is corrected.

The wafer chuck 8 has three through-holes 3. (Only two through-holes 3a and 3b are illustrated in FIG. 1. Hereinafter it is referred to as through-holes 3.) A lift pin 9 is inserted in each of the through-holes 3, and moved vertically by an elevating mechanism 10. (Only two lift pins 9a and 9b among the three lift pins are illustrated in FIG. 1. Hereinafter, it is referred to as lift pins 9.) The lift pins 9 include the elevating mechanism 10 (an up-down mechanism) to load and separate the wafer 1 on and from the outer circumferential rim 5 and the projection portions 6. In the wafer chuck 8, the lift pins 9 are mounted in such a manner that they can protrude from the through-holes 3.

The lift pins 9 also include a vacuum pipe system 12 (a negative pressure suction unit) to attract the wafer 1. The vacuum pipe system 12 is formed to communicate with a negative pressure source, not shown, and when the vacuum pipe system 12 enters a negative pressure status, the wafer is attracted and held. When the elevating mechanism 10 lowers the lift pins 9, the wafer 1 is delivered to the loading surface 2 of the wafer chuck 8.

In the wafer chuck 8, an outlet port 13 (supply unit) is formed to supply a gas into the space surrounded by the outer circumferential rim 5. A pressure source 15 is connected to the outlet port 13, and as the pressure source 15 operates, atmospheric air is supplied from the outlet port 13 to the space surrounded by the outer circumferential rim 5. The pressure source 15 is connected to a control apparatus 14 to transmit pressure information or the like.

The control apparatus 14 (control unit) controls a flow rate of a gas supplied from the outlet port 13, a position of the elevating mechanism 10, and a pressure of the vacuum pipe system 12 of the lift pins 9. The wafer 1 is attracted by the vacuum pipe system 12 at a position where the lift pins 9 protrude higher than the outer circumferential rim 5 and the projection portions 6. When the lift pins 9 are lowered and come to a position close to the outer circumferential rim 5 and the projection portions 6, exhaust of the gas starts via the vacuum pipe system 11. Then, the gas supply from the outlet port 13 starts.

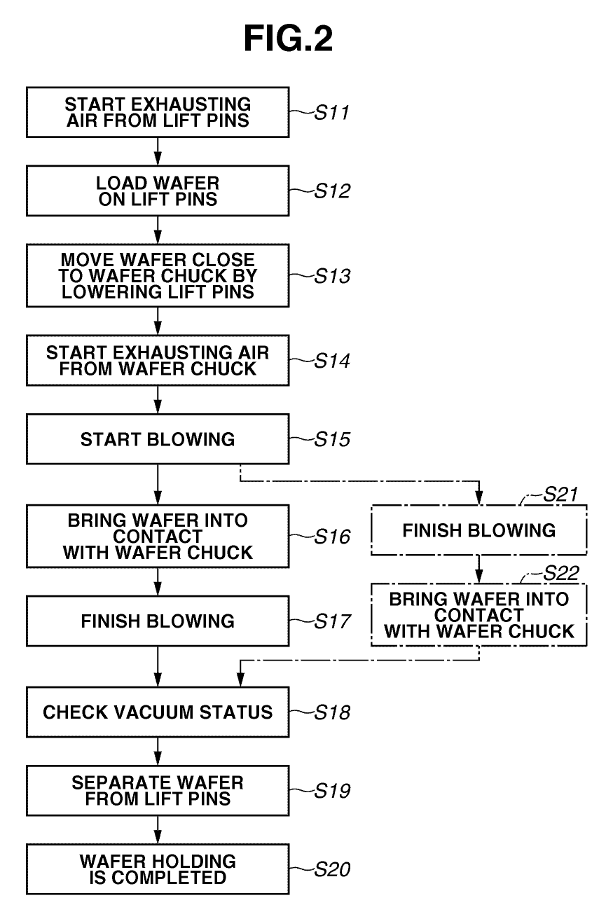

According to the substrate holding method of the present invention, when the wafer 1 is loaded on the above-described substrate holding apparatus, gas is supplied via the outlet port 13 while the gas is discharged by the vacuum pipe system 11. An exposure sequence for performing exposure and transfer is described with reference to the flowchart in FIG. 2.

In step S11, when the lift pins 9 which are moved vertically with respect to the wafer chuck 8 by the elevating mechanism 10 protrude higher than the loading surface 2 of the wafer chuck 8, vacuum suction is started by the vacuum pipe system 11. In step S12, when the wafer 1 as a workpiece is transferred by a conveying hand of an external conveyance apparatus (not illustrated), the wafer 1 is attracted to the lift pins 9 at a position where the lift pins 9 protrude above the loading surface 2.

In step S13, when the conveying hand is retracted, the elevating mechanism 10 operates to lower the lift pins 9, and when the wafer 1 approaches the wafer chuck 8, vacuum suction is performed to load the wafer 1 on the loading surface 2. In step S14, under this condition, the vacuum pipe system 11 performs vacuum suction of the wafer 1. In other words, the wafer 1 is attracted to the lift pins 9 when the lift pins 9 protrude beyond the loading surface 2. When the lift pins 9 are lowered, the wafer 1 approached the wafer chuck 8, the vacuum suction is performed by the vacuum pipe system 11.

Under this condition, a position of the elevating mechanism and a pressure value of the pressure source 15 are controlled by the control apparatus 14. Therefore, in step S15, gas is supplied through the outlet port 13 from the pressure source 15 to slow a pressure drop around the outlet port 13.

As soon as the wafer 1 is loaded on the loading surface 2 in step S16, then in step S17, supply of the gas from the pressure source 15 is finished to maintain the vacuum status. When loading of the wafer is completed, vacuum holding by the vacuum pipe system 12 of the lift pins 9 is stopped. The wafer 1 is loaded on a first peripheral ridge portion 4, the outer circumferential rim 5, and the loading surfaces 2 of a plurality of the projection portions 6 by using a negative pressure.

According to the present exemplary embodiment, during vacuum holding of the wafer 1 to the wafer chuck 8, if the wafer is attracted while exhausting gas, a sharp pressure drop can be suppressed in the surrounding area of the outlet port. Though not illustrated in the present exemplary embodiment, in step S18, a device for measuring a pressure of the loading surface 2 maybe embedded in the wafer chuck 8, and according to obtained pressure information, a flow rate of the outlet port 13 may be adjusted.

Under this condition, a semiconductor exposure apparatus performs exposure and transfer to the wafer 1. In step S19, after exposure and transfer are finished, the wafer 1 is separated from the lift pins 9 by performing the above described operations in a reverse order. In step S20, holding of the wafer 1 on the substrate holding apparatus is completed, and the wafer 1 is recovered.

Accordingly, the present exemplary embodiment can reduce frictional force that occurs on the loading surface 2 after the attraction of the wafer and distortion that is generated on the surface of the wafer 1. Further, the present exemplary embodiment can improve process yield by attracting a wafer while the exhausting gas.

Since a sharp pressure drop can be suppressed when the wafer is attracted, distortion that remains in the wafer after the attraction can be decreased. If exposure is performed to a wafer which is attracted on the substrate holding apparatus according to the present exemplary embodiment, device fabrication can be performed with high accuracy.

In the above exposure sequence, under a condition that blowing is started in step S15 and a pressure drop in the surrounding area of the gas outlets is moderated, when the attraction of the wafer 1 to the loading surface 2 is finished, gas supply from the pressure source 15 in step S17 is finished. However, as indicated by a dashed-dotted line in the flowchart in FIG. 2, an effect described above can be obtained if blowing is finished after a predetermined period of time is elapsed in step S21 and the wafer is attracted to the wafer chuck 8 in step S22, then the vacuum status is checked in step S18.

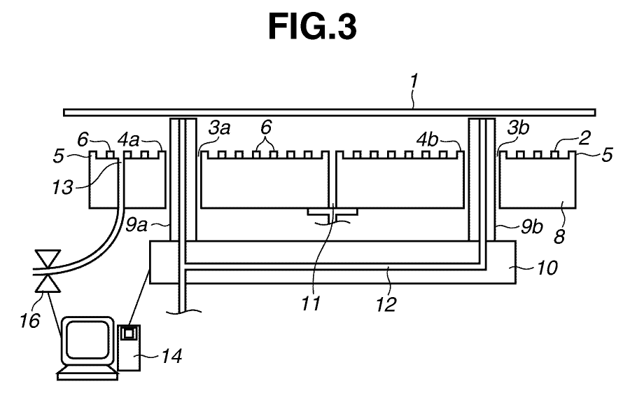

A second exemplary embodiment of the present invention is described with reference to a schematic diagram in FIG. 3. In FIG. 3, same reference numerals are used to components that are similar to those in FIG. 1, and their descriptions are not repeated. The present exemplary embodiment is the same as the first exemplary embodiment except for a gas supply method.

In the present exemplary embodiment, the outlet port 13 is connected to an openable and closable electromagnetic valve 16 which is open at its end to the atmosphere. The flow rate of the gas is adjusted according to open/close operations of the electromagnetic valve 16. Because the end of the electromagnetic value 16 is open to the atmosphere, when the electromagnetic valve 16 is opened, the air is supplied via the outlet port 13. Therefore, the volume of gas supply can be controlled by adjusting the open/close of the electromagnetic valve 16.

The control apparatus 14 controls open/close operations of the electromagnetic valve 16. By controlling the opening and closing of the valve, gas supply is controlled. The control apparatus 14 controls the position of the elevating mechanism 10, and further controls the pressure of the vacuum pipe system 12 of the lift pins 9.

In the above described configuration, an exposure sequence of the substrate holding apparatus related to the exposure apparatus is similar to that in steps S11 to S14 and step S18 or later in the flowchart in FIG. 2 in the first exemplary embodiment, thus their descriptions are not repeated.

While vacuum suction is performed in the wafer chuck 8 by the vacuum pipe system 11, the electromagnetic valve 16 opens in response to information from the control apparatus 14, and supplies gas via the outlet port 13. By supplying the gas, a pressure drop around the outlet port 13 can be moderated.

When loading of the wafer 1 on the loading surface 2 is completed, the electromagnetic valve 16 is closed to shift a state from atmospheric pressure to negative pressure to maintain the vacuum status. The following steps are similar to those in the flowchart in FIG. 2, and their descriptions are not repeated.

According to the present exemplary embodiment, during vacuum holding of the wafer 1 to the wafer chuck 8, if the wafer is attracted while exhausting gas, a sharp pressure drop can be suppressed in the surrounding area of the outlet port. Accordingly, the present exemplary embodiment can reduce frictional force that occurs on the loading surface 2 after the attraction of the wafer and distortion that is generated on the surface of the wafer 1. Further, the present exemplary embodiment can improve process yield by attracting a wafer while the exhausting gas.

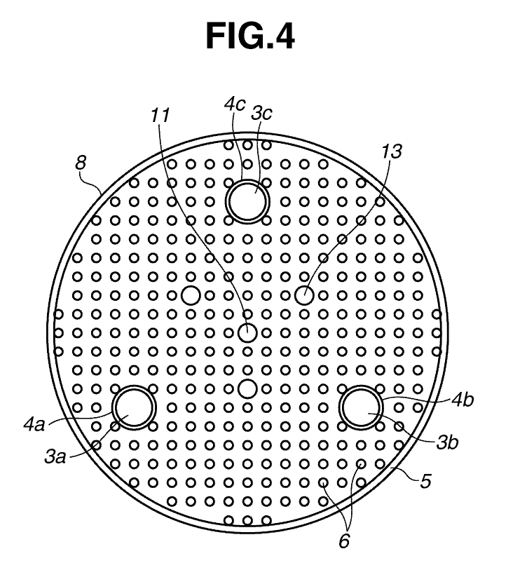

A third exemplary embodiment of the present invention is described referring to a schematic diagram in FIG. 4.

Though sectional views were used in FIGS. 1 and 3, a plan view is used in description of the third exemplary embodiment. In FIGS. 1 and 3 illustrating the first and second exemplary embodiments, the outlet port 13 for gas are arranged in the outer circumferential area. Whereas the outlet port 13 for gas is arranged in the vicinity of the center of the wafer chuck in the third exemplary embodiment illustrated in FIG. 4. Operations of the third exemplary embodiment are similar to those in the first and second exemplary embodiments. In FIG. 4, same reference numerals are used to components that are similar to those in FIG. 1, and their descriptions are not repeated.

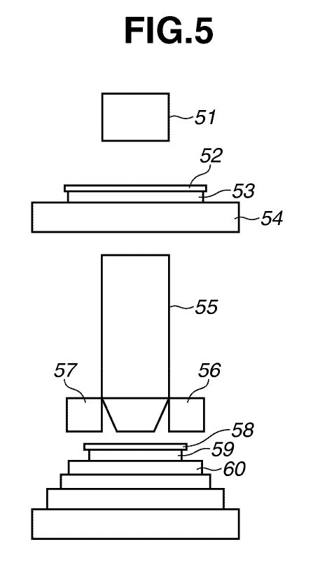

FIG. 5 illustrates an example of an exposure apparatus, which includes the substrate holding apparatus of the present invention. Referring to FIG. 5, the exposure apparatus is described below.

An illumination optical system 51 emits exposure light from a light source (not shown) to a reticle 52 as an exposure original plate. The reticle 52 is held on a reticle chuck 53, and the reticle chuck 53 is held on a reticle stage 54. Therefore, when the reticle stage 54 moves, the reticle 52 is moved.

Exposure light which has passed through the reticle 52 is reduced to, for example, ⅕ of its quantity by a projection optical system 55 which includes optical elements and emitted to a substrate 58 as a workpiece such as a wafer. A wafer chuck 59 as a substrate holding apparatus configured to hold the substrate 58 is mounted on a wafer stage 60 capable of moving the substrate 58 on a horizontal surface.

Next, an exposure sequence of the substrate holding apparatus related to the above-described exposure apparatus.

After the substrate 58 is set automatically or manually on the exposure apparatus, an exposure operation of the exposure apparatus is started by an exposure start command. A first piece of the substrate 58 is conveyed by a conveyance apparatus, not shown, to the wafer chuck 59 on the wafer stage 60.

Delivery of the wafer 58 from the conveyance apparatus to the wafer chuck 59 is performed via conventional lift pins 9 which have been described above. A plurality of alignment marks on the substrate 58 loaded on the wafer stage 60 are detected by an off-axis scope 57. Based on a detection result, magnification, rotation, and X-axis and Y-axis displacements of the substrate 58 are determined, and a position of the substrate 58 is corrected.

The wafer stage 60 positions the substrate 58 to a first shot exposure position, and adjusts a focal position by a surface measurement device 56, then a first shot exposure is performed. After the first shot exposure, the wafer stage 60 moves the substrate 58 to a second shot exposure position by a step motion, and in this manner, exposure is repeated. When a final shot exposure is finished, the wafer stage 60 moves the substrate 58 to a delivery position, delivers the exposed substrate 58 to the conveyance apparatus, and receives next substrate 58 for exposure.

In the present exemplary embodiment, since a substrate holding apparatus of the above described exemplary embodiments is used as the wafer chuck 59, high-precision exposure can be performed while suppressing local deformation in the substrate 58 without deteriorating process yield.

Devices, such as semiconductor integrated circuit elements and liquid crystal display elements, can be formed and manufactured by exposing photoresist-coated substrates (wafer, glass plate, for example) and by developing the exposed substrates by an exposure apparatus of the above described exemplary embodiments. A processing operation of the developed substrates includes etching, resist separation, dicing, bonding, packaging, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-305681 filed Nov. 28, 2008, which is hereby incorporated by reference herein in its entirety.

What is claimed is:

1. A substrate holding apparatus configured to hold a substrate by vacuum holding, the substrate holding apparatus comprising:
a rim which has a circumferential shape and is configured to support the substrate;
a projection portion configured to support the substrate in an inner area surrounded by the rim;
an exhaust unit configured to exhaust gas from an inner space within the rim to attract and support the substrate;
a lift pin configured to load the substrate on the rim and the projection portion;
a supply unit configured to supply gas to the space surrounded by the rim; and
a control unit configured to control a flow rate of the gas supplied from the supply unit,
wherein when the gas is exhausted by the exhaust unit, the control unit starts supplying the gas before the substrate contacts the rim and the projection portion, and controls the flow rate of the supplied gas in order to reduce a deformation in the substrate caused by exhaust of the gas.

2. The substrate holding apparatus according to claim 1, wherein the supply unit includes an electromagnetic valve whose end portion is open to the atmosphere, and the flow rate of the supplied gas is adjusted by opening and closing of the electromagnetic valve.

3. The substrate holding apparatus according to claim 1, wherein the lift pin includes a negative pressure suction portion to attract the substrate, the substrate is attracted by the negative pressure suction portion at a position where the lift pin protrudes above the rim and the projection portion, and when the lift pin lowers and comes close to the rim and the projection portion, the exhaust unit starts exhausting the gas, then the supply unit starts to supply the gas.

4. The substrate holding apparatus according to claim 1, wherein three lift pins are provided.

5. A method for holding a substrate in a substrate holding apparatus which includes a rim which has a circumferential shape and is configured to support the substrate, a projection portion configured to support the substrate in an inner area surrounded by the rim, an exhaust unit configured to exhaust gas from an inner space within the rim to attract and support the substrate, a lift pin configured to load the substrate on the rim and the projection portion, and, a supply unit configured to supply gas to the space surrounded by the rim, the method comprising:
when the substrate is loaded, exhausting the gas by the exhaust unit while supplying the gas by the supply unit to reduce a deformation in the substrate caused by the exhaust; and
loading the substrate on the rim and the projection portion.

6. An exposure apparatus configured to expose a substrate to a pattern on an original, the exposure apparatus comprising:
a projection optical system configured to project the pattern of the original to the substrate; and
a substrate holding apparatus configured to hold the substrate,
the substrate holding apparatus includes:
a rim which has a circumferential shape and is configured to support the substrate;
a projection portion configured to support the substrate in an inner area surrounded by the rim;
an exhaust unit configured to exhaust gas from an inner space within the rim to attract and support the substrate;
a lift pin configured to load the substrate on the rim and the projection portion;
a supply unit configured to supply gas to the space surrounded by the rim; and
a control unit configured to control a flow rate of the gas supplied from the supply unit,
wherein when the gas is exhausted by the exhaust unit, the control unit starts to supply the gas before the substrate contacts the rim and the projection portion, and controls the flow rate of the supplied gas in order to reduce a deformation in the substrate caused by the exhaust of the gas.

7. A method for manufacturing a device, comprising:
exposing a substrate by an exposure apparatus,
the exposure apparatus including:
a projection optical system configured to project the pattern of the original to the substrate; and
a substrate holding apparatus configured to hold the substrate,
the substrate holding apparatus including:
a rim which has a circumferential shape and is configured to support the substrate;
a projection portion configured to support the substrate within an inner area surrounded by the rim;
an exhaust unit configured to exhaust gas from an inner space within the rim to attract and support the substrate;
a lift pin configured to load the substrate on the rim and the projection portion;
a supply unit configured to supply gas to the space surrounded by the rim; and
a control unit configured to control a flow rate of the gas supplied from the supply unit,
wherein when the gas is exhausted by the exhaust unit, the control unit starts to supply the gas before the substrate contacts the rim and the projection portion, and controls the flow rate of the supplied gas in order to reduce a deformation in the substrate caused by the exhaust of the gas; and
developing the exposed substrate.

8. A substrate holding apparatus configured to hold a substrate with vacuum by loading the substrate while exhausting the gas from a space, the substrate holding apparatus comprising:
a supply unit configured to supply gas into the space; and
a control unit configured to control a flow rate of the gas supplied from the supply unit,
wherein the control unit starts supplying the gas before the substrate is loaded and controls the flow rate of the supplied gas in order to reduce deformation in the substrate caused by the exhaust of the gas.
